(19) United States
(12) Patent Application Publication
(10) Pub. No.: US 2013/0271010 A1
(43) Pub. Date: Oct. 17, 2013

(54) Presence detector and a lighting system

(71) Applicants: Giovanni Cennini, Eindhoven (NL); Dmitri Anatolievich Chestakov, Eindhoven (NL); Mark Thomas Johnson, Arendonk (BE)

(72) Inventors: Giovanni Cennini, Eindhoven (NL); Dmitri Anatolievich Chestakov, Eindhoven (NL); Mark Thomas Johnson, Arendonk (BE)

(73) Assignee: KONINKLIJKE PHILIPS N.V., EINDHOVEN (NL)

(21) Appl. No.: 13/997,708

(22) PCT Filed: Dec. 12, 2011
(86) PCT No.: PCT/IB11/55613

§ 371 Date: Jun. 25, 2013

(30) Foreign Application Priority Data
Dec. 29, 2010 (EP) 10197230.5

(51) Int. Cl. G01J 5/00; H05B 37/02; G01J 5/34

(52) U.S. Cl. CPC G01J 5/0025; G01J 5/34; H05B 37/0227
USPC 315/149; 250/338.3

(57) ABSTRACT

A detector (1) for detection of a presence of a living being (10) comprises at least one pyroelectric cell (2A;2B) for detection of the presence of the living being (10) and for producing a corresponding detection signal (6). The detection signal (6) comprises at least one living being's vital signal. The detector comprises a processor unit (8) for concluding the presence of the living being (10) based on the detection signal (6) and on the vital signal. Such detector is characterized with the relative high certainty when detecting the presence of the living being. The invention further relates to a lighting system comprising the above described detector.

### FIELD OF THE INVENTION

The invention relates to a detector for detecting a presence of a living being. The detector comprises at least one pyroelectric cell for detection of the presence of the living being and for producing a corresponding detection signal. The detector comprises a processor unit for concluding the presence of the living being based on the detection signal. The invention further relates to a lighting system comprising the above mentioned detector.

### BACKGROUND OF THE INVENTION

As it is known in the art, a Passive InfraRed sensor (PIR sensor) is an electronic device that measures infrared (IR) light radiating from objects in its field of view. PIR sensors are often used in the construction of PIR-based motion and/or presence detectors. The motion is detected when an infrared source with one temperature, such as a human, passes in front of an infrared source with another temperature, such as a wall. All objects emit what is known as black body radiation. It is usually infrared radiation that is invisible to the human eye but can be detected by electronic devices designed for such a purpose. The term passive in this instance means that the PIR device does not emit an infrared beam but merely passively accepts incoming infrared radiation “Infra” meaning below our ability to detect it visually, and “Red” because this color represents the lowest energy level that our eyes can sense before it becomes invisible. Thus, infrared means below the energy level of the color red, and applies to many sources of invisible energy. In a PIR-based motion detector (usually called a PID, for Passive Infrared Detector), the PIR sensor is typically mounted on a printed circuit board containing the necessary electronics required to interpret signals from the PIR sensor.

A drawback of the known PIR sensor is that it characterized with a relatively limited certainty when detecting the presence of a living being, in particular a human or an animal. Such sensor reacts only on a motion of the living being.

### SUMMARY OF THE INVENTION

It is an object of the present invention to provide a detector that is suitable for detecting a presence of a living being. The living being can be a human or an animal. Such a detector is characterized with a relative high certainty when detecting the presence of the living being. This object is achieved with the detector according to the invention as defined in Claim 1. The detector for detecting a motion and a presence of a living being comprises at least one pyroelectric cell for detection of the presence of the living being and for producing a corresponding detection signal. The detection signal comprises at least one living being's vital signs, which will henceforth be referred to as the vital signal, for example, in case that the living being is a human, a heart rate of the human. The detector further comprises a processor unit for concluding the presence of the living being based on the detection signal and on the vital signal.

That means that the detector according to the invention provides to the processor both the detection signal and the vital signal comprised by the detection signal. The presence detection of the living being by the processor unit is based on both signals. For this reason the detector according to the invention is characterized with a relatively high certainty when detecting the presence of the living being and consequently the detector overcomes the drawback of the known PIR sensor.

An embodiment of the detector according to the invention has the feature that the detector comprises at least two pyroelectric cells. Such a detector provides further improvement of the presence detection since it employs at least two pyroelectric cells.

An embodiment of the detector according to the invention has the feature that the detector comprises at least one infrared filter. One of the pyroelectric cells is equipped with the infrared filter which is sensitive to a region of the thermal radiation spectrum at a wavelength range below the wavelength of the thermal black body radiation of the living being. The infrared filter can be sensitive to radiation below 8 microns, and preferably below 5 microns and more preferably below 2 microns.

An embodiment of the detector according to the invention has the feature that the detector comprises at least two infrared filters. Each of the pyroelectric cells is equipped with one of the infrared filters. Each of the infrared filters is sensitive to a different region of the thermal radiation spectrum wherein the regions are not overlapping with each other.

An embodiment of the detector according to the invention has the feature that the infrared filters are made from polymethyl methacrylate.

The above described embodiments of the detector according to the invention can be used for detection for more than one living being. The corresponding vital signals that are detected are different from each other. For example, if the living beings are two humans and if the vital signals are heart rates of these two humans, the heart rates of two humans are never exactly the same. Thus, the detection signal will comprise two or more different vital signals, each of them corresponding to a different living being. The processor unit will conclude the presence of more than one living being. The processor unit can also conclude the number of living beings which presence is detected.

The invention further relates to a lighting system comprising the detector as described in the previous embodiments and a light source for illuminating an area. The detector is arranged for controlling the light source based on the presence detection by the detector.

### BRIEF DESCRIPTION OF THE DRAWINGS

In the following, the invention and further aspects will be described, by way of example, and explained hereinafter, using the following figures:

FIG. 1 schematically shows an equivalent circuit of a pyroelectric cell as it is known in the art;

FIGS. 2A; 2B schematically show a scheme of motion detection with a Passive Infrared (PIR) sensor as it is known in the art and corresponding signals;

FIG. 3 schematically shows a first exemplary embodiment of the detector according to the invention;

FIG. 4 schematically shows (a) the detector comprising a pyroelectric cell equipped with an infrared filter and (b) an absorption spectrum of such filter;

FIG. 5 schematically shows signals originating from the detector shown in FIG. 3, wherein (a) shows the signals when the detector is not equipped with the infrared filters and wherein (b) shows the signals when the detector is equipped with infrared filters;

FIG. 6 schematically shows signals from the detector equipped with the infrared filters, wherein (a) shows the signals in the time domain and wherein (b) shows the signals in the frequency domain;

FIG. 7 schematically shows (a) a schematic view of the detector equipped with the infrared filters and (b) spectral characteristics of the infrared filters.

### DETAILED DESCRIPTION OF THE EMBODIMENTS

In the following description of the preferred embodiments, reference is made to the accompanying drawings which form a part thereof. Specific embodiments, in which the invention may be practiced, are shown in the following description by way of illustration. It is also understood that other embodiments may be utilized and structural changes may be made without departing from the scope of the present invention. It is noted that the same reference signs will be used for indicating the same or similar parts in the several embodiments.

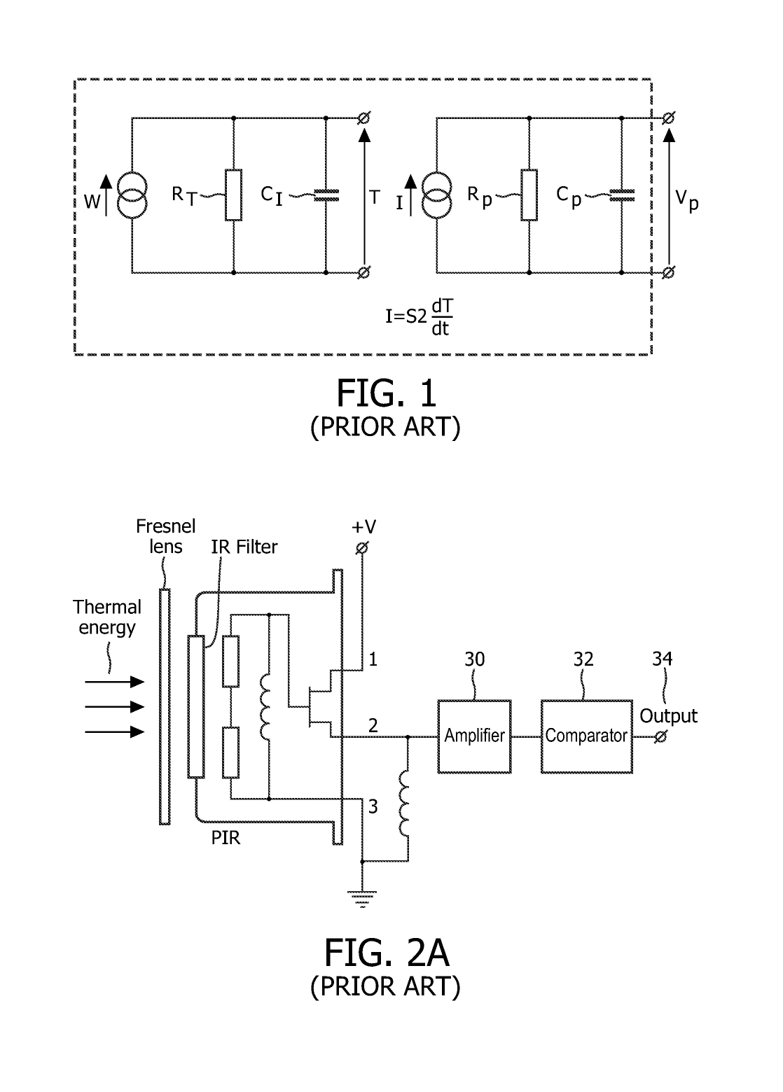

FIG. 1 schematically shows an equivalent circuit of a pyroelectric cell as it is known in the art. Passive infrared (PIR) sensors, as known in the art, comprise two or more pyroelectric cells. These pyroelectric cells are connected in a differential way whereby they remove the direct component of the heat signal and generate an output signal that represents the difference of the output of all cell elements.

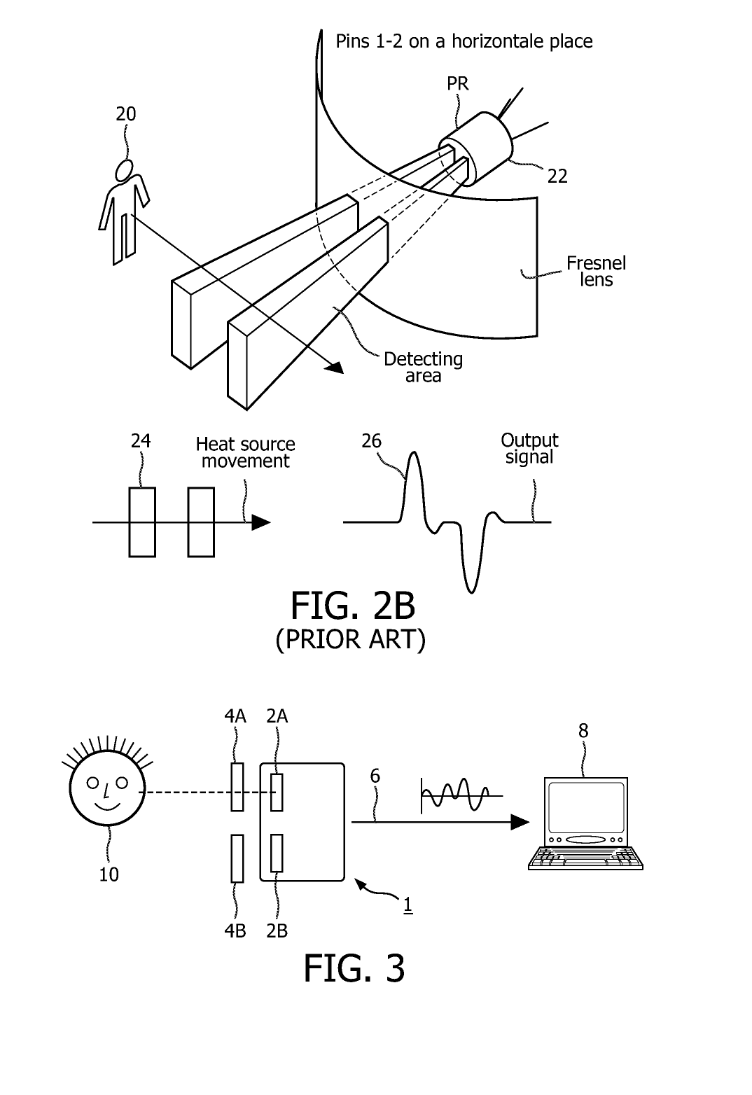

FIG. 2A schematically shows a scheme of motion detection with a PIR sensor as it is known in the art. As it is shown in FIG. 2A, the PIR sensor can also comprise an additional amplifier 30 and a comparator 32 that creates a digital output 34 each time the pyroelectric cells measure a change in the thermal radiation distribution, as caused by the movement of a warm object such as a human in the vicinity of the sensor.

The way of working of such PIR sensor is shown in FIG. 2B. When a human 20 is passing the PIR sensor 22, the consequent heat source movement, represented by the input signal 24, will produce an output signal 26 shown in the FIG. 2B.

A drawback of the known PIR sensors is that their differential detection technique tends to eliminate or at least substantially reduce any vital signals from the human. This results because the vital signals are detected with fairly similar intensity with both sensing elements and hence effectively cancelled out by subtraction of one signal from the other during the differential detection.

A detector 1 for detecting a motion and a presence of a living being 10 according to the invention is schematically shown in FIG. 3. The detector comprises at least one pyroelectric cell 2A;2B for detection of the presence of a living being 10. The human being can be a human or an animal. The FIG. 3 shows an example with two pyroelectric cells 2A;2B. The pyroelectric cell 2A;2B produces a corresponding detection signal 6. The detection signal 6 comprises at least one living being's vital signal, for example the human being's hearth rate. The detector comprises a processor unit 8 for concluding the presence of the living being 10 based on the detection signal 6 and on the vital signal. The presence detection obtained in this way is of a relatively high precision since it is based on both the detection signal and on the vital signal.

As shown in the FIG. 3, the detector 1 can comprise two pyroelectric cells 2A;2B and two infrared filters 4A;4B. Each of the pyroelectric cells 2A;2B is equipped with one of the infrared filters 4A;4B. Each of the infrared filters 4A;4B is sensitive to a different region of the thermal radiation spectrum wherein the regions are not overlapping, or at least substantially not overlapping, with each other.

As already stated, the living being can be a human or an animal. In case that the living being is a human, the human's vital signal can be a heart rate signal, a heart rate variation signal, a respiration rate signal etc.

Differently from the PIR sensors known in the art, the detector according to the invention does not comprise the comparator and the pyroelectric cells 2A;2B do not operate in a differential mode. As a consequence there is no subtraction of the measured signals and the vital signal is therefore not removed by subtraction. The pyroelectric cells 2A;2B therefore produce an analogue signal which comprises the living being's vital signal, for example the heart rate signal, which can subsequently be extracted.

The detector according to the invention does not require continuous illumination of environment since it can be used in the infrared (IR) range, wherein there is little to no light from the common lighting sources. The detector uses only the heat signal as radiated by the living being and as such requires no illumination of the environment to operate.

The detector comprising the pyroelectric cells 2A;2B according to the invention is able to measure the heart rate of people from a distance by collecting the light from the skin. In a range of 700-1200 nm, oxygenated blood has high light absorption, and substantial absorption in the range from 1200 nm-2200 nm. Variations of the light intensity caused by absorption of blood oxygen can be detected. This is known in the art as photoplethysmography.

The infrared filters 4A;4B can be an optical filter with an opportune transmission spectrum in the thermal radiation region of the light. The infrared filters can be placed on top of the pyroelectric cells 2A;2B. The detector may further comprise electronic units consisting of digital and/or analogue filters and amplifiers and\or a display device to visualize the detection results.

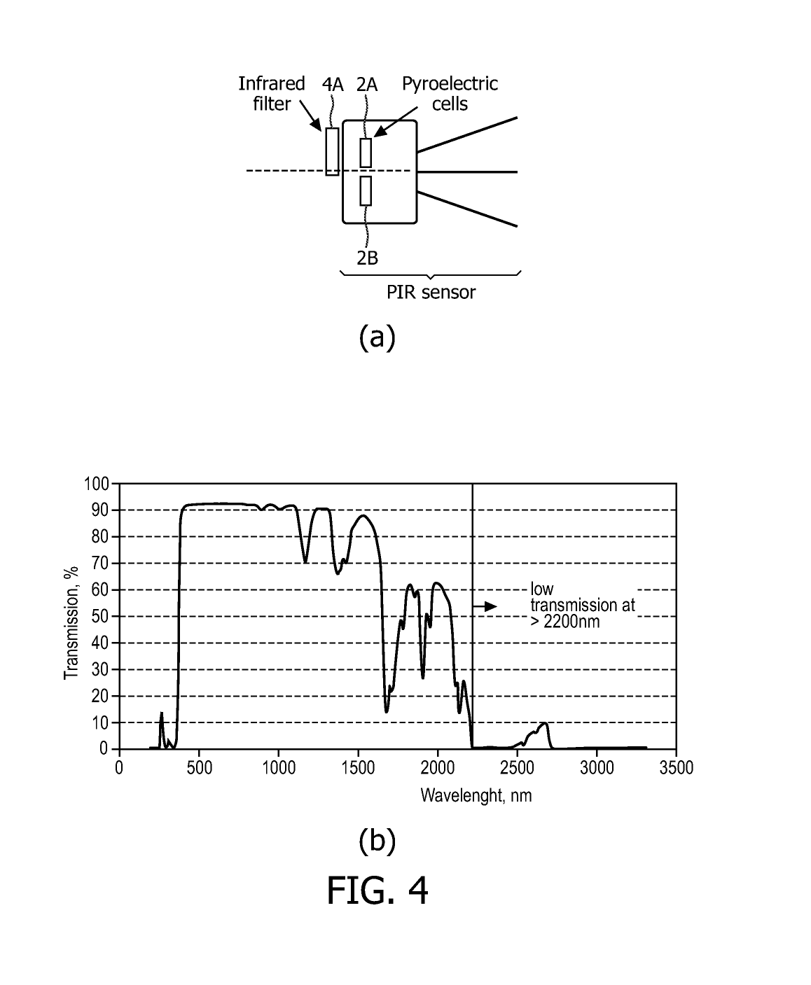

The infrared filters 4A;4B are preferably made of polymethyl methacrylate (PMMA). This material is transparent in the visible range but completely absorptive in the infrared range. For wavelengths above 2.2 microns PMMA absorbs 100% of light. FIG. 4(a) schematically shows the scheme of the pyroelectric cells 2A;2B equipped with the PMMA infrared filter 4A. FIG. 4(b) schematically shows the transmission of such filter for different light wavelengths.

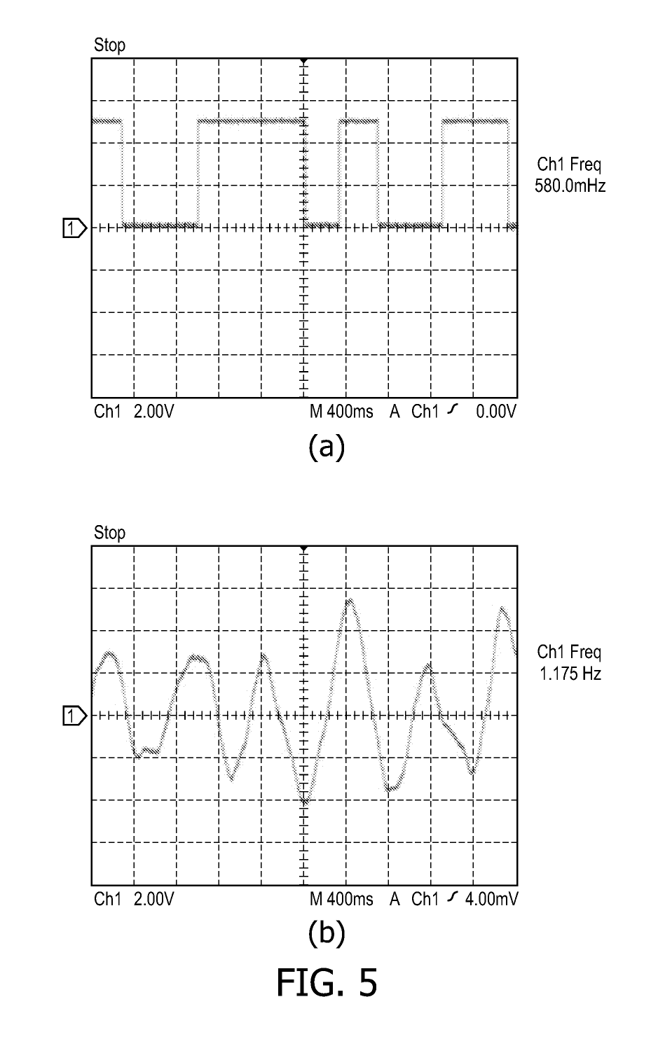

Without the PMMA filter, a typical signal from the PIR sensor, as it is known in the art, is shown in FIG. 5(a). It is possible to observe a signal of a digital type, which is created by subtraction of the signals from the two pyroelectric cells.

Using the PMMA filter according to the invention it is possible to observe a signal of an analogue type. Such a signal is shown in FIG. 5(b). This signal is suitable for the living being's vital signal measurements, for example the heart rate measurements.

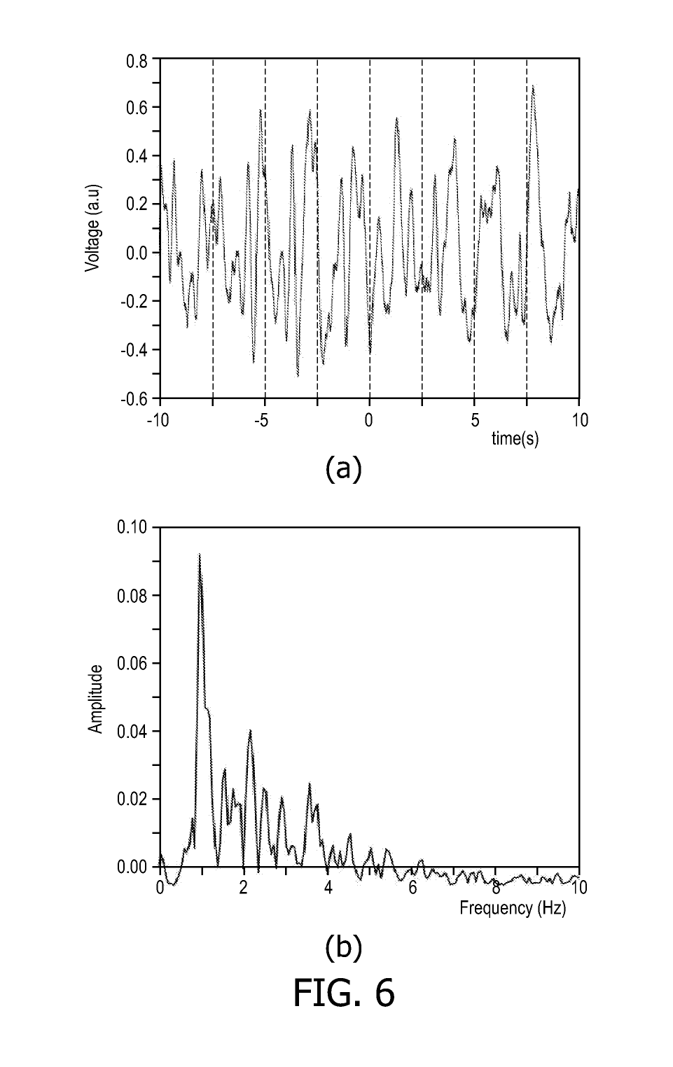

FIG. 6(a) shows 20 seconds of acquired signal produced by the pyroelectric cell 2A;2B equipped with PMMA filter 4A;4B. The radiation is collected from a human's face over a time period of 20 seconds. FIG. 6(b) shows the frequency spectrum of the signal shown in FIG. 6(a), converted by, in the art known, Fast Fourier Transform (FFT). The signal shown in FIG. 6(b) has a peak at 1 Hertz (Hz). This peak represents the heart rate of the human, wherein the human has a heart rate of 60 beats per minute.

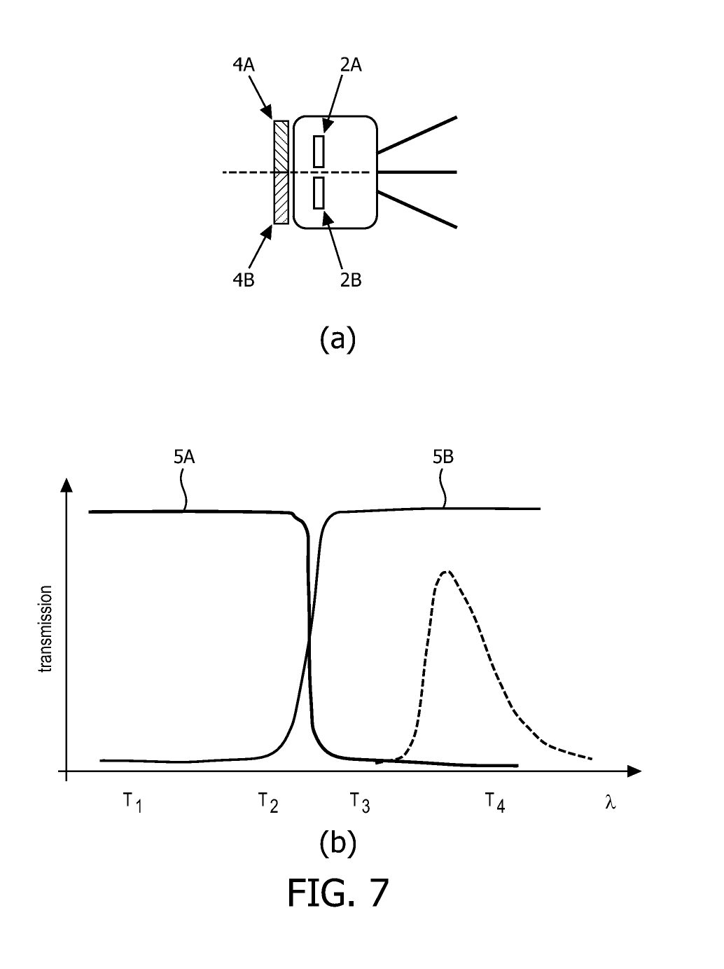

Each of the pyroelectric cells 2A;2B receives thermal radiation from an opportune wavelength range. The following equation results from the Wien law, as known in the art, of the displacement of the wavelength as function of the temperature for a black body radiator:

$${λ}_{M} = \frac{a}{T}$$

wherein T is the temperature in Kelvin, λ is the wavelength and a=>2.8978×10−3 (m K). Typical human body temperatures are about 37° C., corresponding to a typical wavelength of 9.5 μm. The detector according the invention discloses different infrared filters, a first infrared filter 4A and a second infrared filter 4B, for different pyroelectric cells, a first pyroelectric cell 2A and a second pyroelectric cell 2B, as shown in FIG. 7(a). As it is shown in FIG. 7(b), the first infrared filter 4A transmits 5A radiation corresponding to temperature below T2, and the second infrared filter 4B transmits 5B radiation corresponding to temperature above T3. It is possible to tailor the infrared filters so that a suitable choice of temperatures can be realized. In particular for a human's heart rate detection, one filter, in this example the second infrared filter 4B, should be transmissive in a range near 9.5 micrometer (μm). This range can be for example from 8 μm to 12 μm. The other filter, in this example the first infrared filter 4A, blocks the radiation from this range, for example the PMMA filter as shown in FIG. 4. As described above, this filter is suitable for measurement of the vital signal. Hence, such detector enables to detect both the motion and the human's vital signal, such as the heart rate.

It is important to note that a person skilled in the art can tailor the filters so that a suitable overlap can be realized. It is also possible that the temperature points T2 and T3, as shown in FIG. 7(b), are the same, or may even overlap slightly. The temperature of the human is represented by T4.

If the detector comprises more than two pyroelectric cells, for example 3, 4 or more, then the same number of the infrared filters will be used. In such case the arrangement of the infrared filters can be chosen for two or more regions of the thermal spectrum.

The detector as claimed by the invention can be used in a lighting control systems, motion detection systems, presence detection systems, non invasive measurements of heart rate, etc. For example, a lighting system comprising the detector, as described in the previous embodiments, and a light source for illuminating an area. The detector can be arranged for controlling the light source based on the presence detection.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. For example, whilst the above embodiments consider the detection of just a single living being by the sensor according to the invention, in further embodiments it will be possible to detect more than one living being with a single sensor. This is enabled by the invention because it discloses a method for determination of the vital signal. The vital signals of different living beings are not the same; for example the heart rate and heart rate variability of different humans are known to be different. By measuring the vital signals of the more than one human using a single detector and analyzing the resulting composite signal using the FFT method described in FIG. 6, the resulting frequency spectrum, of the type shown in FIG. 6b, will in general display distinct peaks at different frequencies. Each of the frequencies will correspond to e.g. the heart rate of an individual living being. As an example, if the vital signal shows a peak measured at 1 Hz, corresponding to a heart rate of 60 Hz from a first human—as in FIG. 6b—and another peak at 0.66 Hz, then this second peak will correspond to a heart rate of 90 Hz, which can unambiguously be interpreted as the presence of a second human. Similarly, more peaks at different frequencies can be interpreted as the presence of more living beings in the proximity of the sensor.

In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

### LIST OF REFERENCE NUMERALS

1 a detector
2A;2B a pyroelectric cell
4A;4B an infrared filter
5A;5B a radiation
6 a detection signal
8 a processor unit
10;20 a living being
22 a PIR sensor
24 a heat source movement
26 an output signal
30 an amplifier
32 a comparator
34 a digital output

1. A detector for detection of a presence of a living being, the detector comprising:
at least two pyroelectric cells for detection of the presence of the living being and for producing a corresponding detection signal (6), wherein the detection signal comprises at least one living being's heat rate,
at least two infrared filters, and
a processor unit for concluding the presence of the living being based on the detection signal and on the heat rate, wherein each of the pyroelectric cells is equipped with one of the at least two infrared filters, wherein one of the at least two pyroelectric cells is equipped with a first of the at least two infrared filters which is sensitive to a region of the thermal radiation spectrum at a wavelength range below the wavelength of the thermal black body radiation of the living being and wherein the other one of the at least two pyroelectric cells is equipped with a second of the at least two infrared filters which is sensitive to a different region of the thermal radiation spectrum, wherein said regions of the thermal radiation spectrum are not overlapping with each other.

2-3. (canceled)

4. The detector as claimed in claim 1, whereby the first of the at least two infrared filters is sensitive to radiation below 8 microns.

5. (canceled)

6. The detector as claimed in claim 4, wherein the living being is a human.

7. The detector as claimed in claim 4, wherein the infrared filter is made from polymethyl methacrylate.

8. A lighting system, comprising the detector as claimed in claim 7 and a light source for illuminating an area, wherein the system is arranged for controlling the light source based on the detector's presence detection.
